(19) United States
(12) Patent Application Publication
(10) Pub. No.: US 2004/0073461 A1
(43) Pub. Date: Apr. 15, 2004

(54) Software program and process for maintaining confidentiality of patient medical information

(76) Inventor: Matt Pappas, Las Vegas, NV (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/458,929

(22) Filed: Jun. 11, 2003

Related U.S. Application Data
(60) Provisional application No. 60/387,807, filed on Jun. 11, 2002.

(51) Int. Cl. G06F 17/60

(52) U.S. Cl. 705/3

(57) ABSTRACT

A method for determining whether a business user in possession of confidential information of an individual may disclose the information in accordance with objective rules voluntarily adopted by the business user or required by law.

(a) providing a series of “wizard” screens that present the user questions about the condition of their office and the business with respect to privacy in a series of logical checkboxes and option buttons that the user selects;

(b) assessing, based on the answers given by the user on the wizard screens and the objective rules;

(c) providing a set of results to the business user indicating what steps need to be taken in order for the business user to comply with said objective rules for disclosure.

Priority claims benefit of U.S. Provisional Patent Application No. 60/387,807 on Jun. 11, 2002, and is hereby incorporated by reference it its entirety.

### BACKGROUND OF THE INVENTION

This invention relates to a process driven software application that provides complete and specific results, suggestions and itemized requirements for maintaining patient confidentiality, disclosure and training information associated with the Health Insurance Portability and Accountability Act of 1996 (HIPAA) Privacy Standards. The invention is a complete, unique and integrated solution to the privacy portion of HIPAA.

Healthcare providers have been required to keep specific patient related information confidential pursuant to the Health Insurance Portability and Accountability Act passed by Congress in 1996. This regulation provides complex rules for disclosure of protected information and specific rules for recording disclosure, notifying patients, making agreements with other providers, vendors and collection companies.

The complex disclosure rules and assessment rules, as well as ancillary requirements that create a need for employee training, make it expensive and difficult for healthcare providers to become compliant and remain compliant with the HIPAA privacy standards.

Presently, there are numerous paper and compact disc based systems that provide the forms required by HIPAA privacy as well as written documentation describing compliance requirements. These form based systems give the providers a basis for setting up their own office system for compliance, but require them to take multiple actions within their offices including external or internal training of employees, some method for recording disclosure, training for a “HIPAA Officer” that must understand and apply the complex disclosure rules and a “gap” assessment that requires the office to review compliance rules and determine what steps must be taken to become privacy compliant. Often times, the setup of this process can be expensive and does not maintain compliance over time—it simply gets the facility into compliance by the required privacy deadline.

The current solutions available to providers are not complete, do not provide a processed based solution, can be very expensive and are time consuming to implement. The current solutions are generally paper-based and there is not a solution that uses a method/process to easily provide results and solutions for the providers.

The object of the invention is to allow healthcare providers to become HIPAA privacy compliant through a complete software solution that incorporates a series of interconnected processes that record, assess, review and reports on information provided by the user, interprets the information using a rules-based system that incorporates the complex HIPAA privacy provisions and then reports the specific results and requirements associated with the assessment and/or disclosure back to the user. With so many requirements covered by HIPAA-Privacy, the invention provides a complete solution that interconnects the various different aspects of the privacy requirements in a single, unique software package.

HIPAA requires that disclosures of protected health information (“patient data”) be made only in certain circumstances and to certain people without specific patient consent. The rule for disclosure is complicated and often involves numerous exceptions and controls. The process for making the determination is provided by a “wizard” tool included in the invention that asks the questions of the user, interprets the information, processes the information in a machine-like fashion specifically in accordance with the HIPAA privacy rules and then provides outcomes to the user indicating necessary forms, whether an exception applies and suggestions to the user so that the user remains safe under the rules.

The HIPAA privacy rules require more than disclosure processing—the rules also require that an assessment be done to ensure that provider facilities are setup in a fashion that avoids improper disclosure of protected information. The invention includes another wizard that asks the user questions about the status of their office, training of employees, special agreements and other HIPAA privacy related matters. From this information, the system determines and recommends actions by the provider to ensure compliance.

Under the HIPAA privacy rules, provider-employers may be responsible for improper disclosures by their employees. Accordingly, the invention includes a novel integrated training system that trains, using integrated computer video, tests, and prints an agreement to be signed and records training historical information on employees that work for the provider. The invention keeps track of employee training and employee agreements for the provider in a complete database.

The invention also includes all of the required forms that a provider must use and a tracking system for recording agreements between a provider and his/her business associates. Under the rules, a provider must have specific agreements in-place with each business associate the provider shares protected information with. The system tracks these agreements and ensures that the agreements are in-place before it suggests whether a disclosure be made under the HIPAA rules.

For six (6) years following certain types of protected information disclosure, the provider must track the disclosure and be able to provide such information to the patient or auditing agencies. The system includes a complete database that records these disclosures in a manner consistent with the requirements of HIPAA privacy.

Providers must provide patients with a specific statement outlining the patient's rights under HIPAA privacy. The invention prints these flyers and acknowledgements for the provider.

### SUMMARY OF THE INVENTION

The present application relates to an invention which is a complete HIPAA privacy assessment, disclosure, reporting, tracking and training tool that utilizes process driven functions to make privacy assessments and disclosure assessments and provide concrete results to the user to ensure the user's proper HIPAA privacy compliance. With this invention, the healthcare provider can become quickly compliant and maintain compliance with HIPAA privacy using a single solution for all of the privacy requirements. From assessment to disclosure to training to patient notification, the invention provides a complete, process based solution for the end-user.

These and other features, advantages and objects of the present invention will be further understood and appreciated by those skilled in the art by reference to the following specification, claims and appended drawings.

### BRIEF DESCRIPTION OF THE DRAWINGS

FIG. 1 is main introductory screen embodying the present invention;

FIGS. 2-5 are patient detail screens embodying the present invention;

FIGS. 6-9 are disclosure wizard screen embodying the present invention;

FIGS. 10-15 are privacy assessment/gap analysis and welcome wizard embodying the present invention;

FIG. 16 is human resources and compliancy screen embodying the present invention;

FIG. 17 is policies and forms screen embodying the present invention;

FIGS. 18-19 are employee training screens and testing screens utilizing AVI graphic files embodying the present invention;

FIG. 20 is business associate agreement screens embodying the present invention;

FIG. 21 is patient complaint screen embodying the present invention;

FIG. 22 is SafeScreen screen saver embodying the present invention;

FIG. 23 is user selection screen embodying the present invention;

FIG. 24 is advanced program configuration screen embodying the present invention.

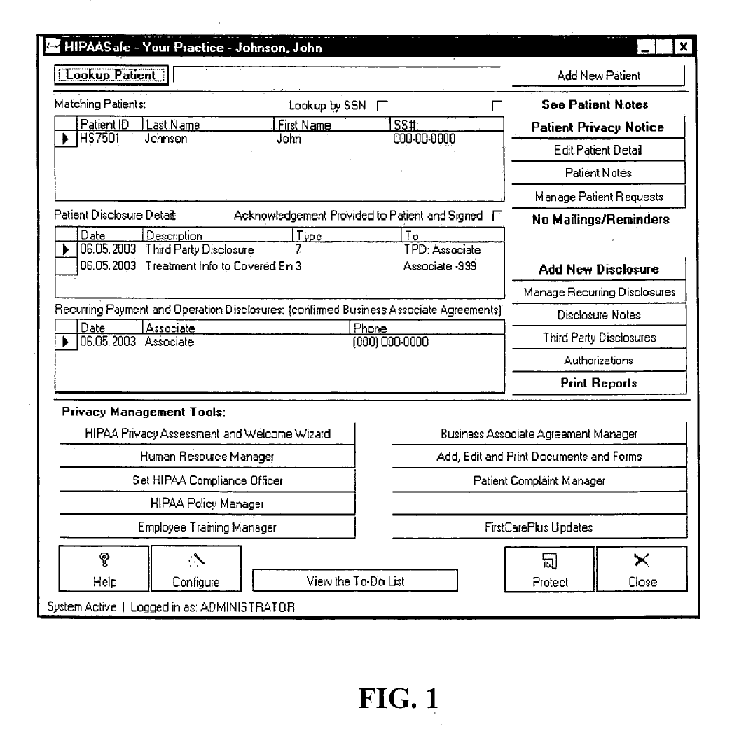

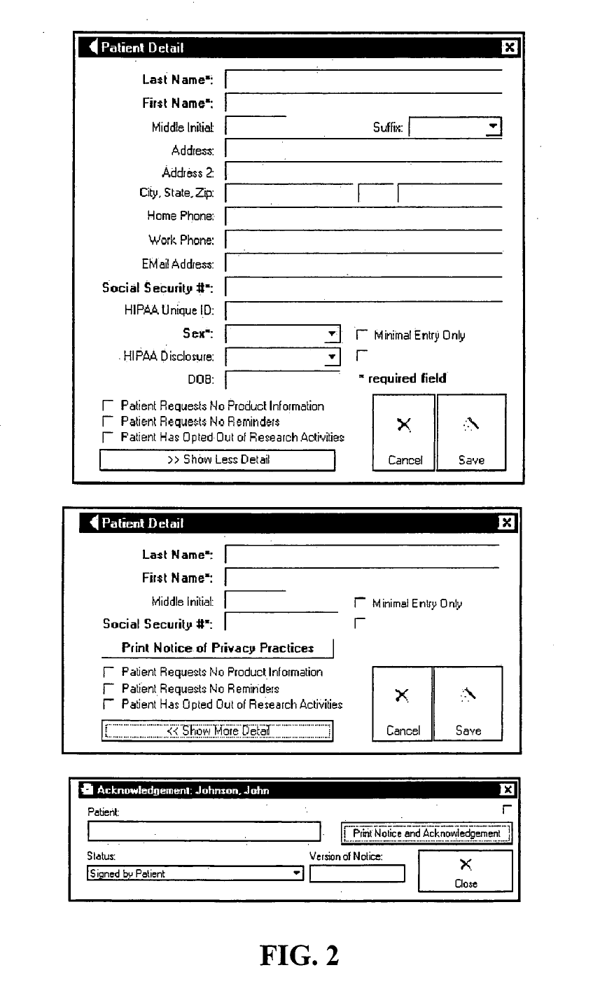

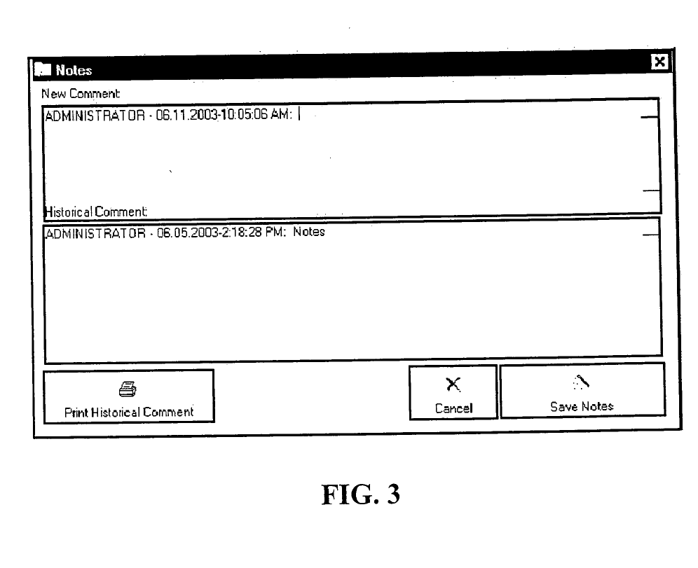

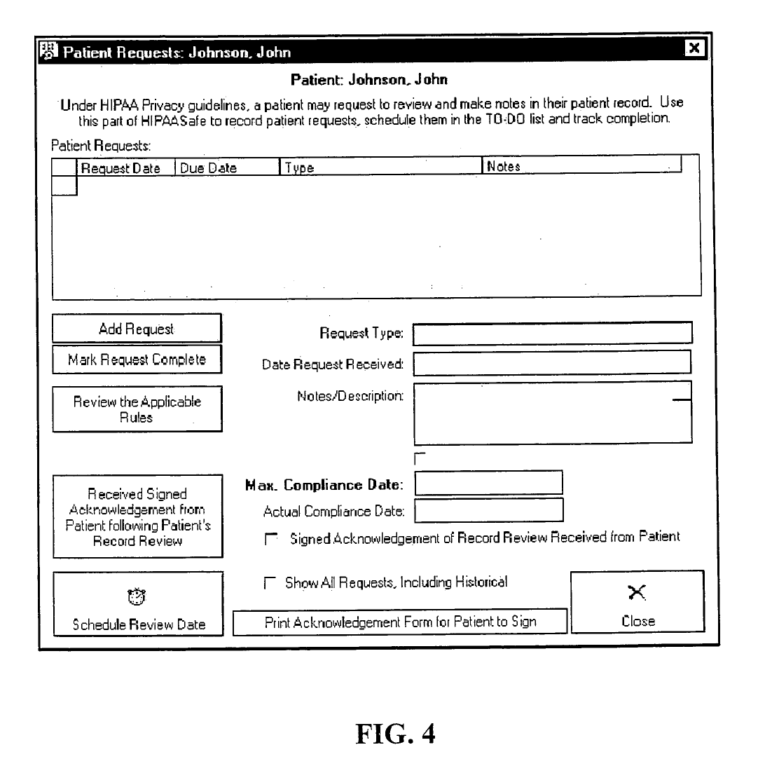

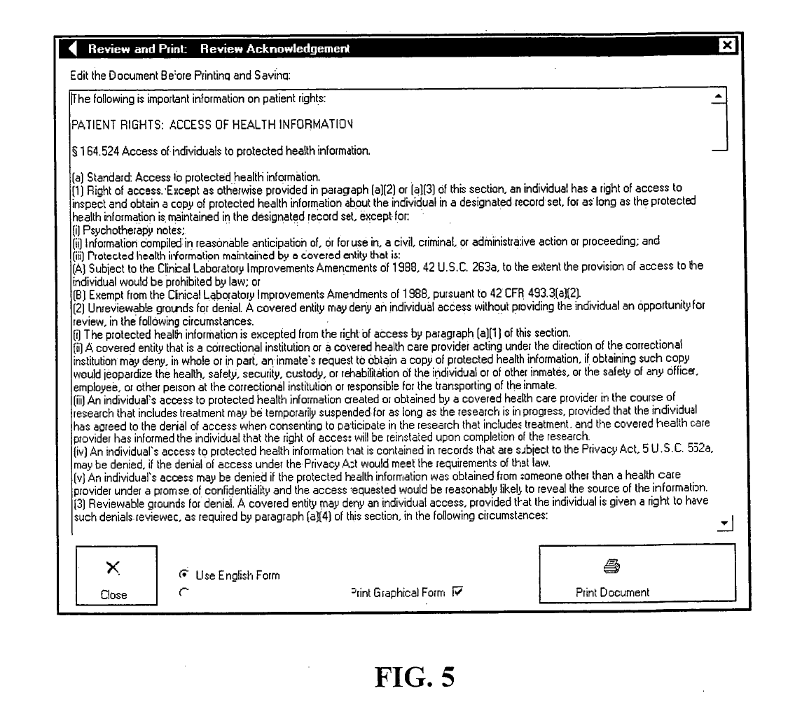

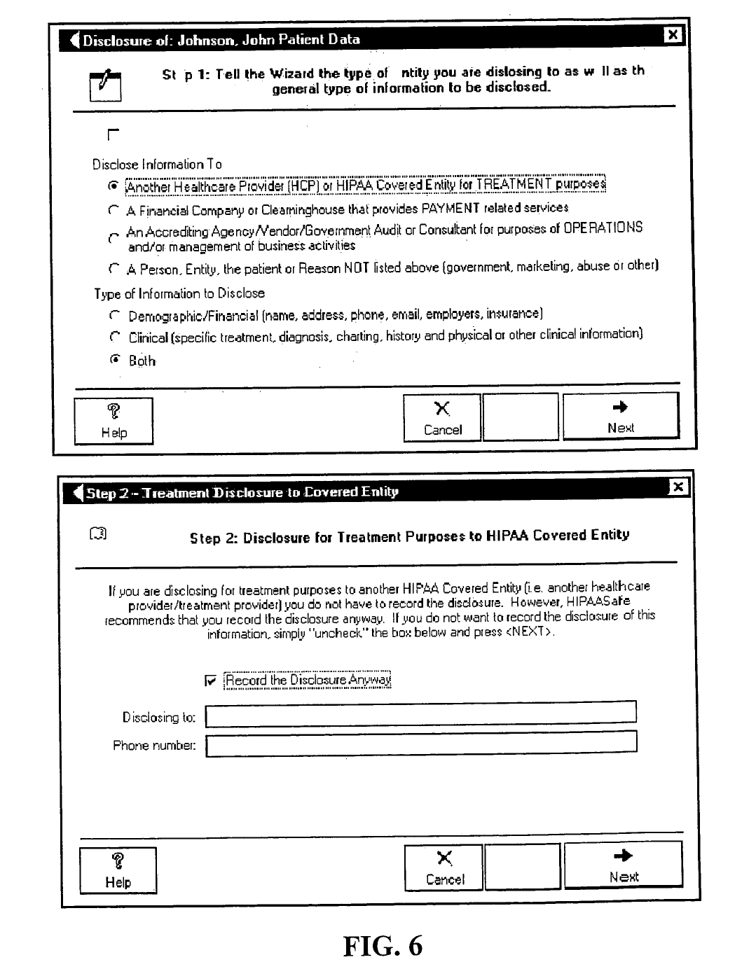

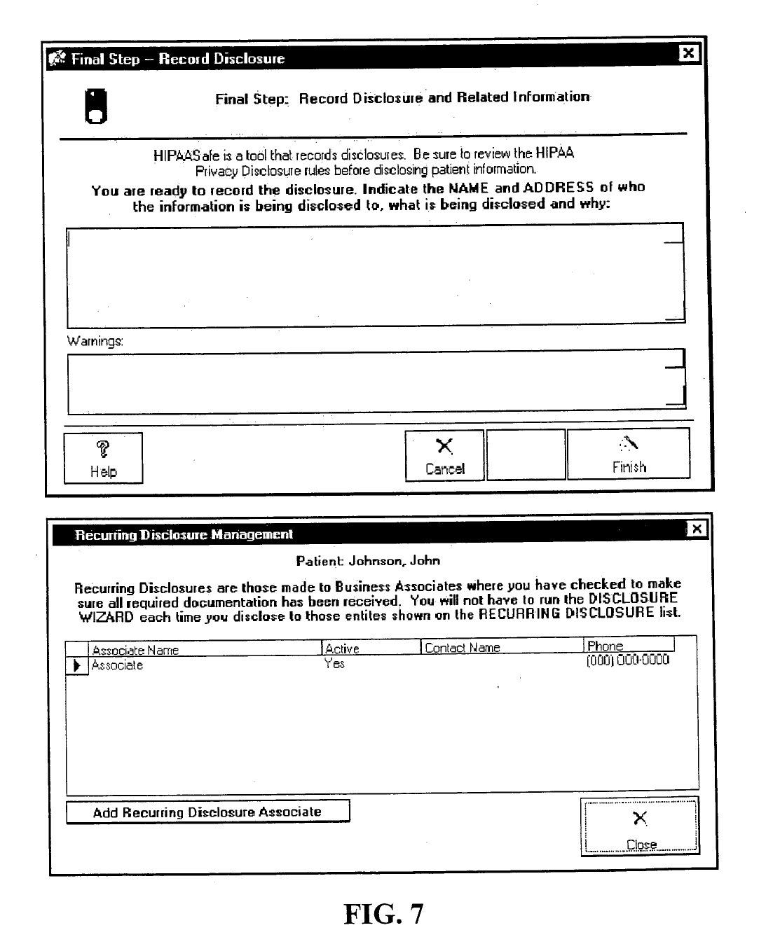

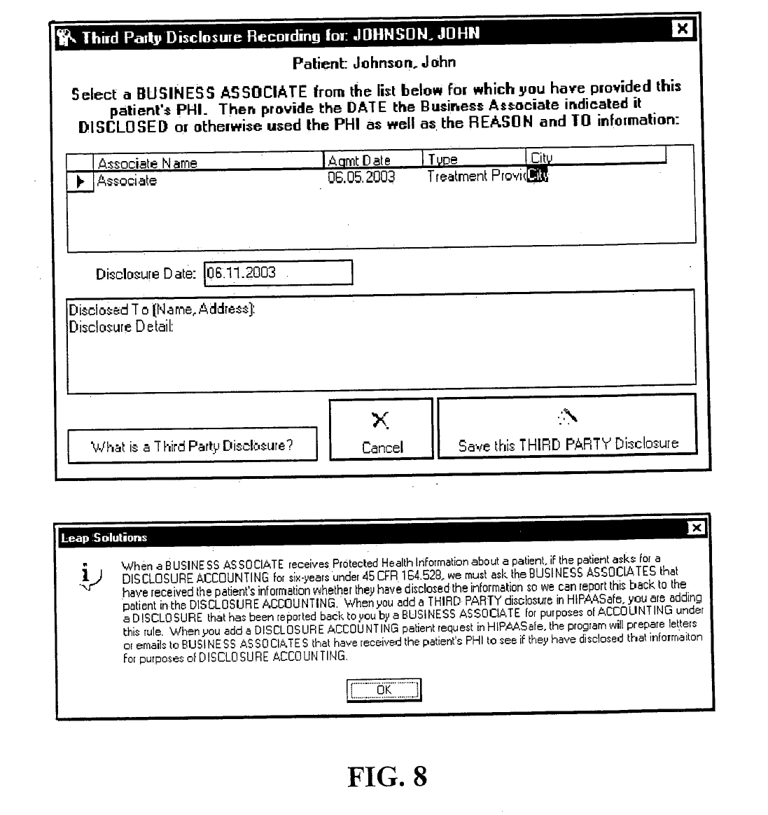

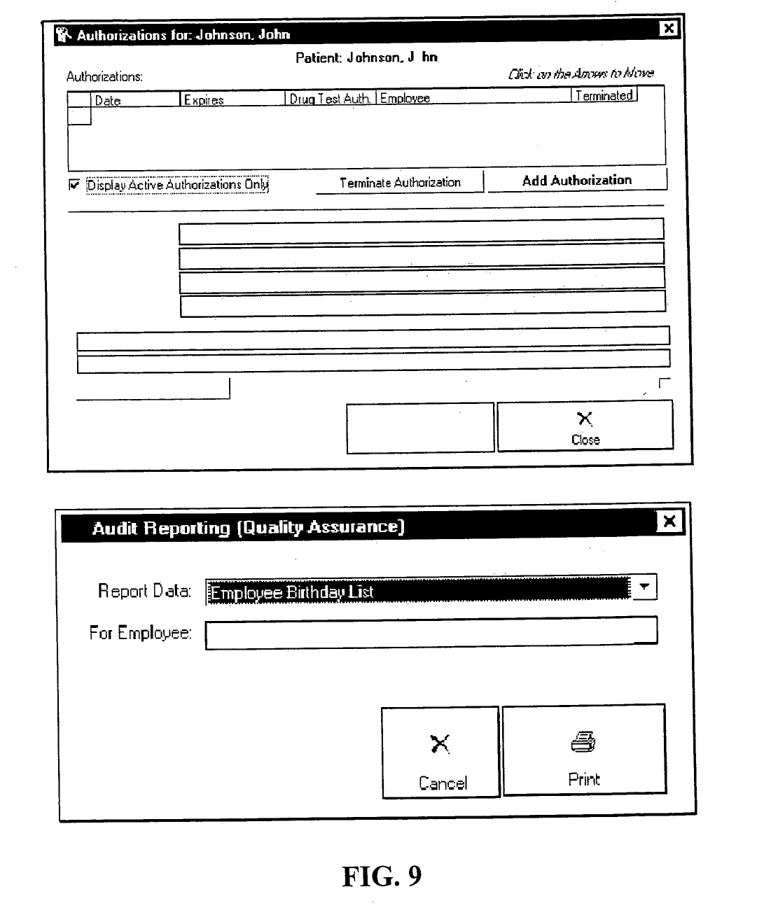

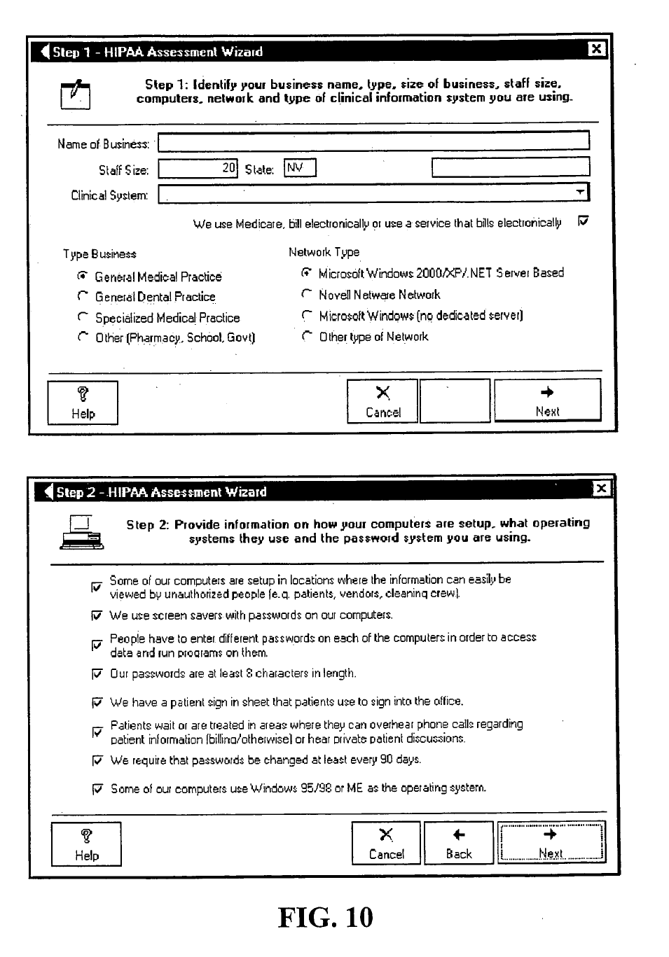

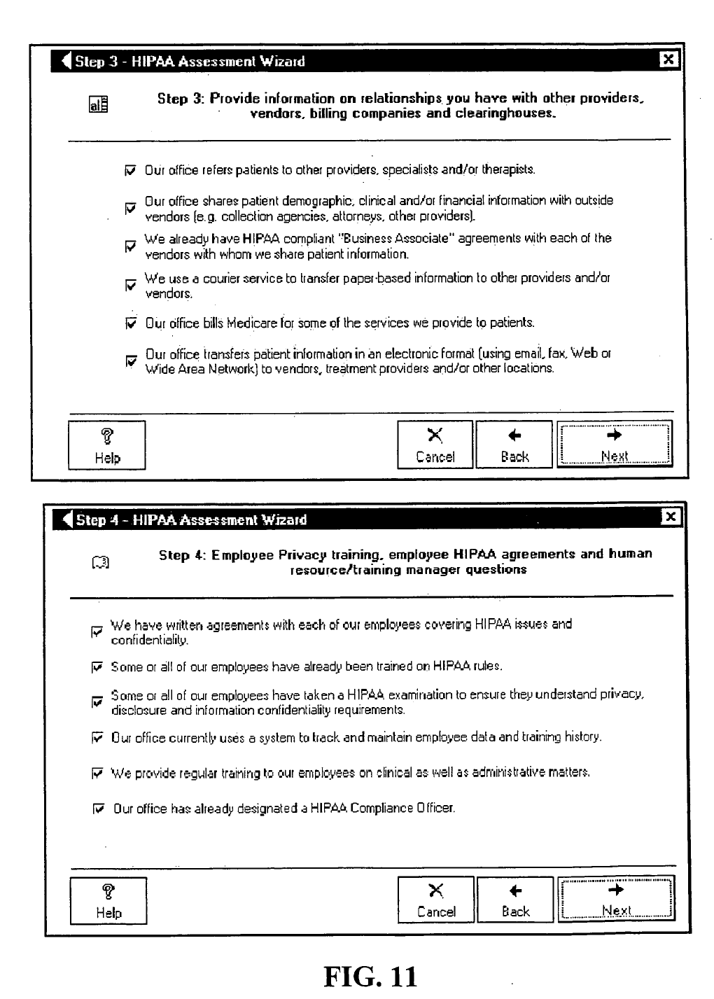

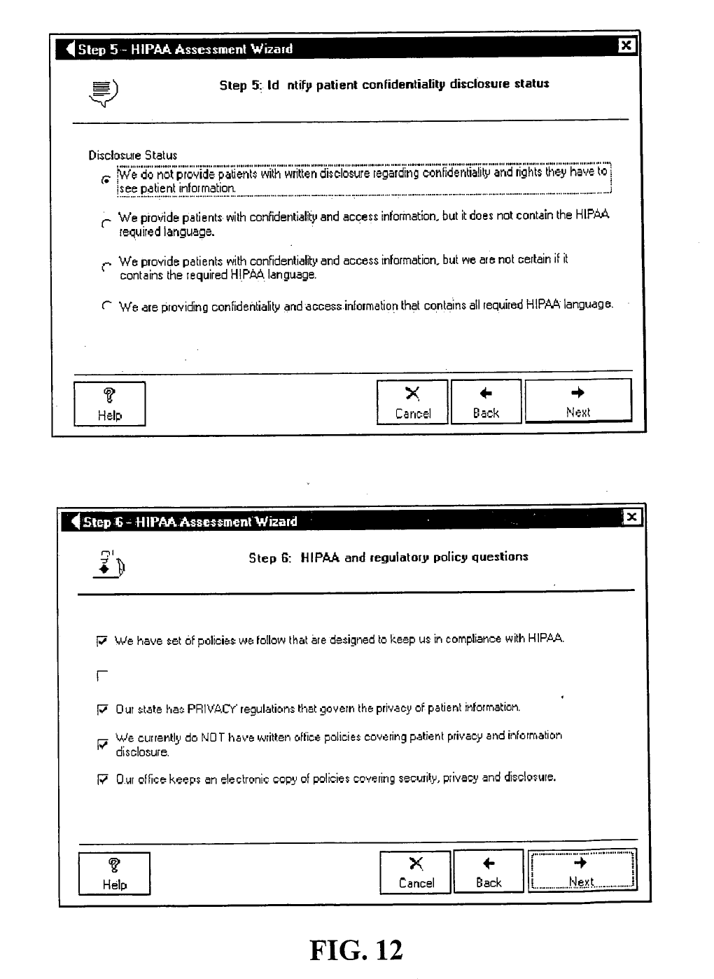

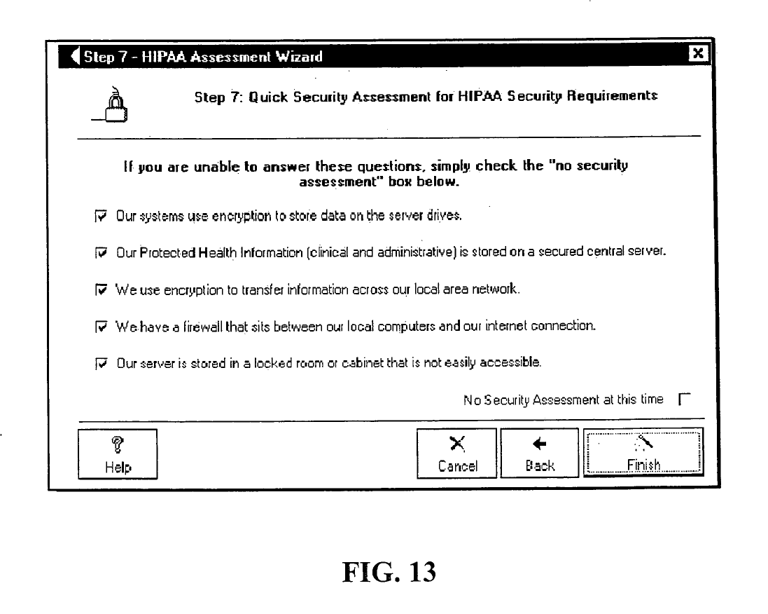

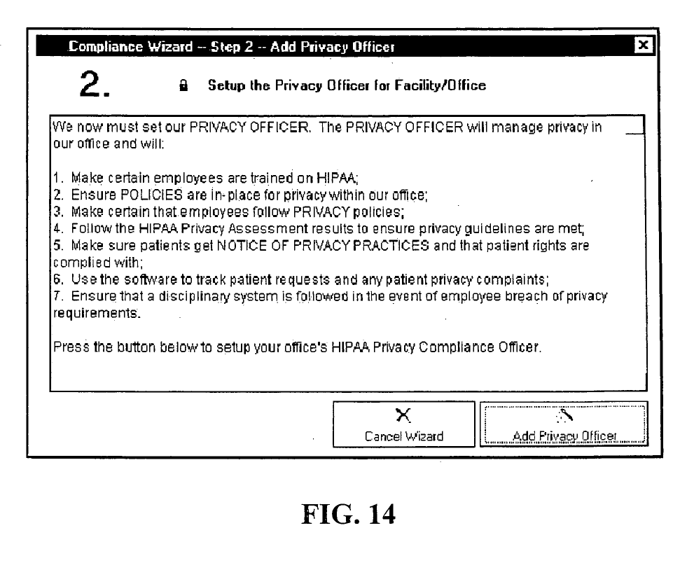

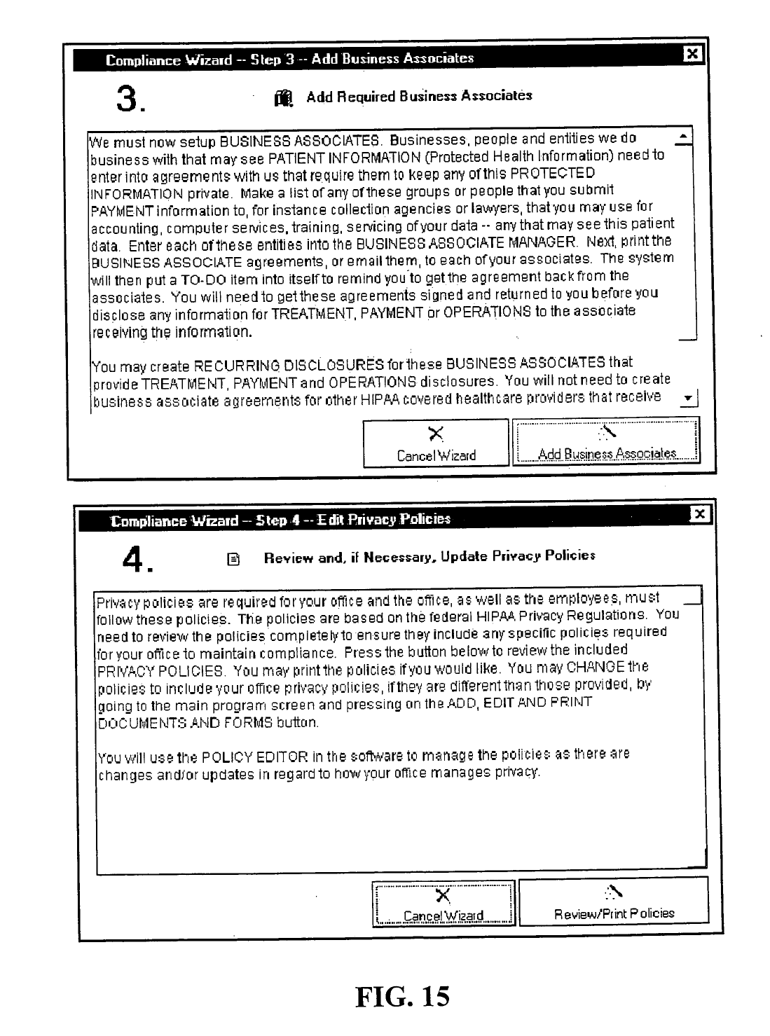

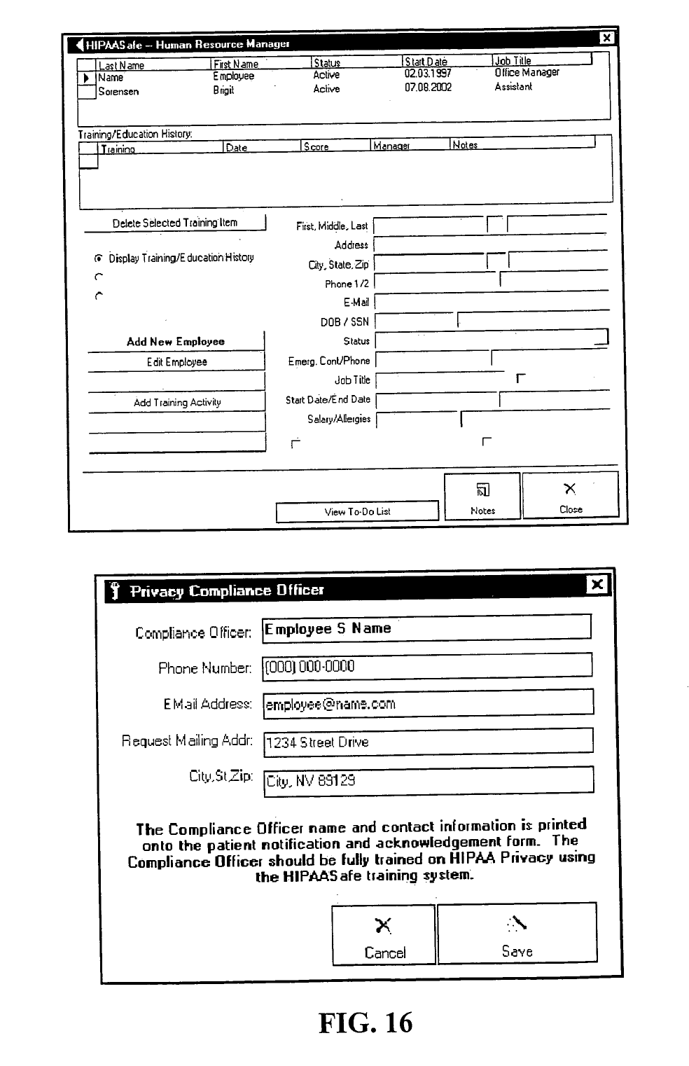

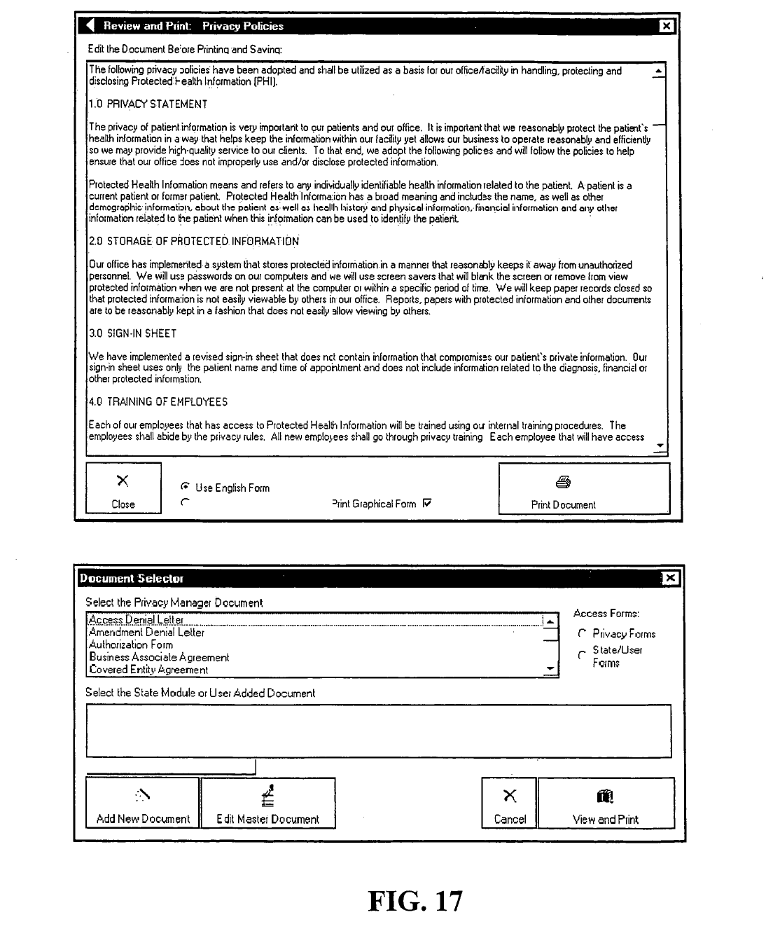

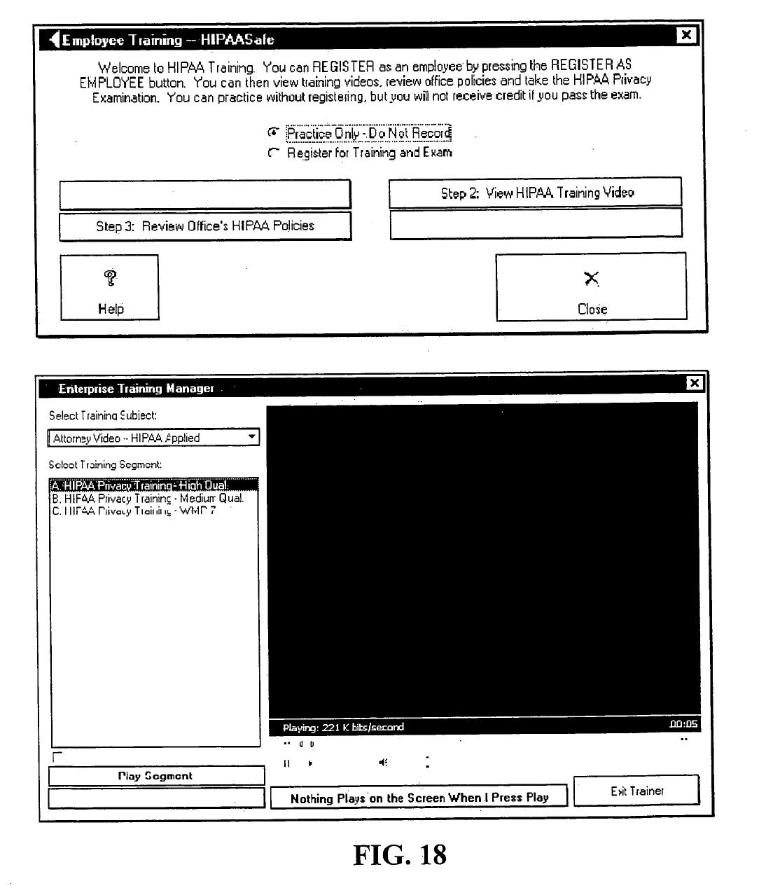

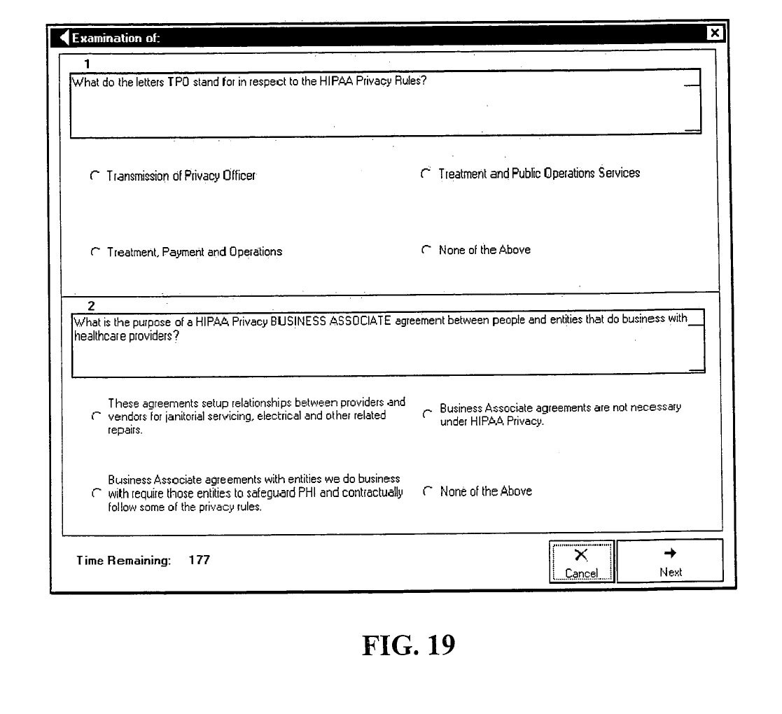

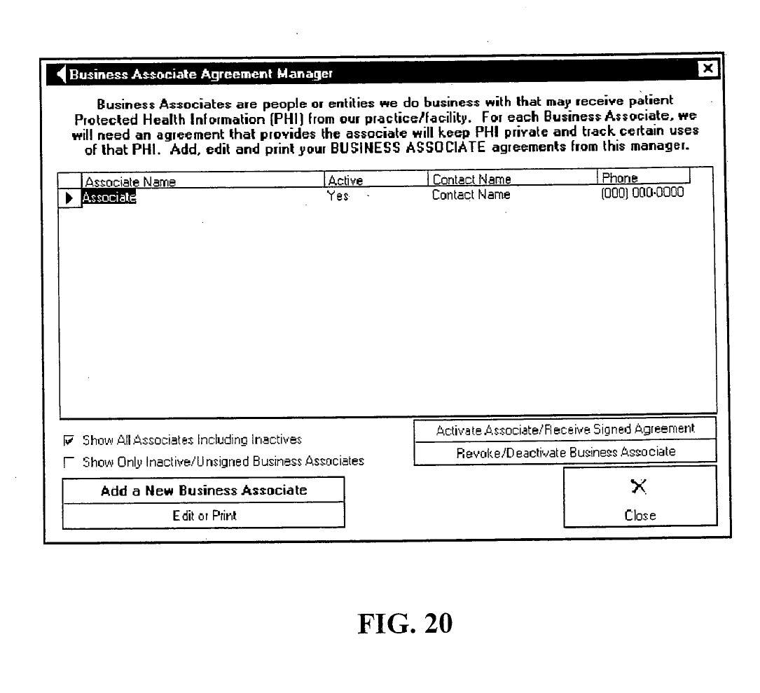

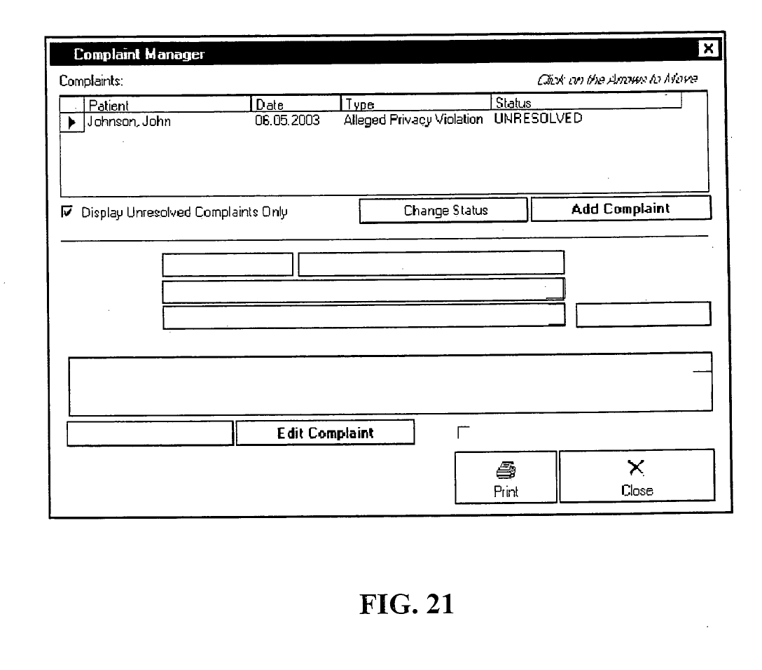

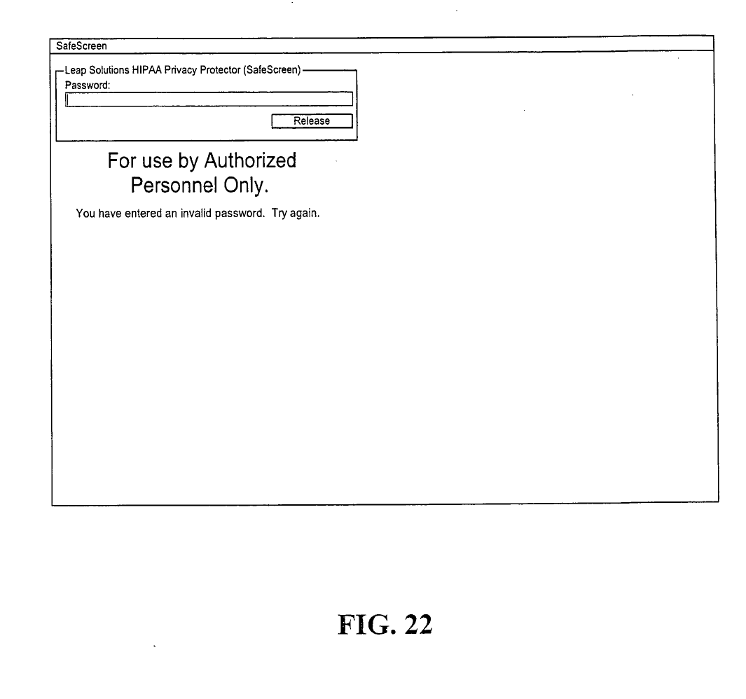

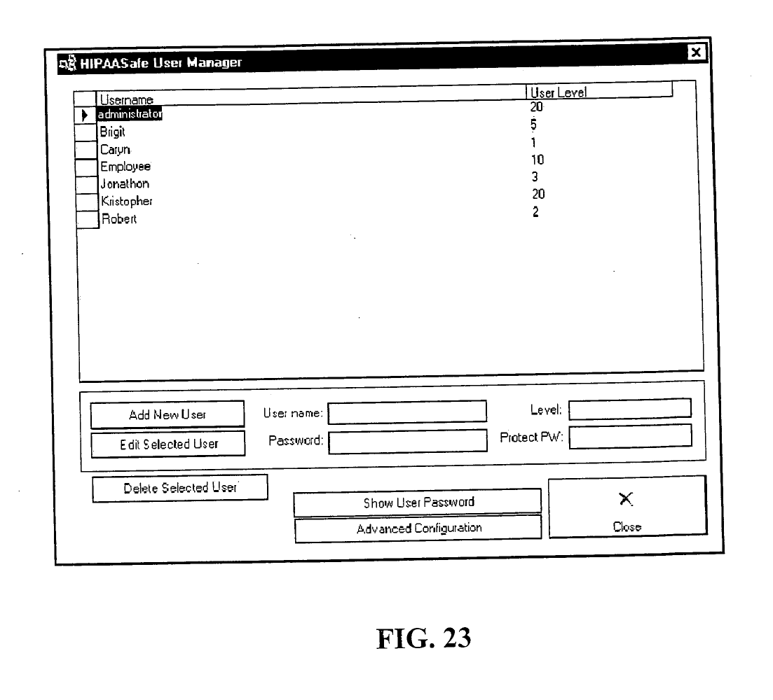

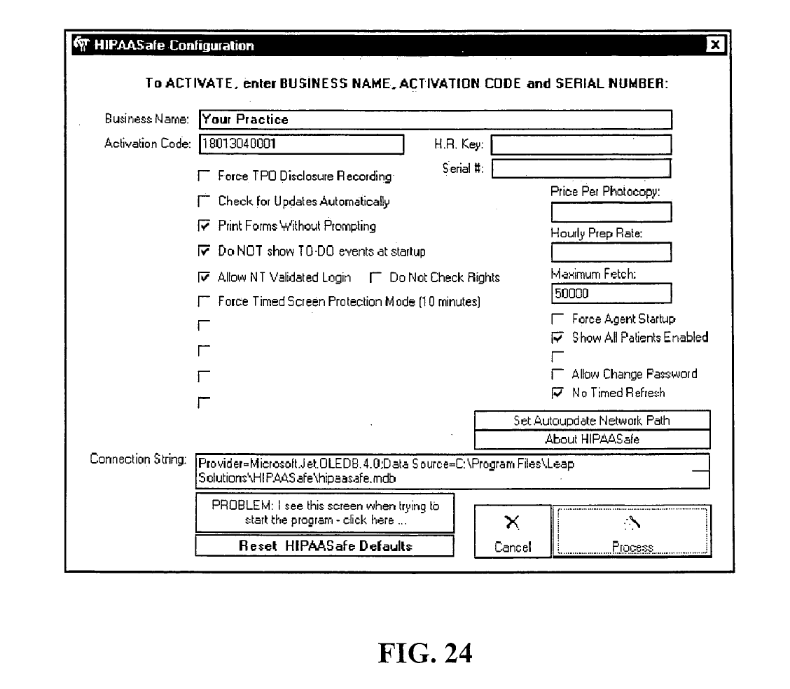

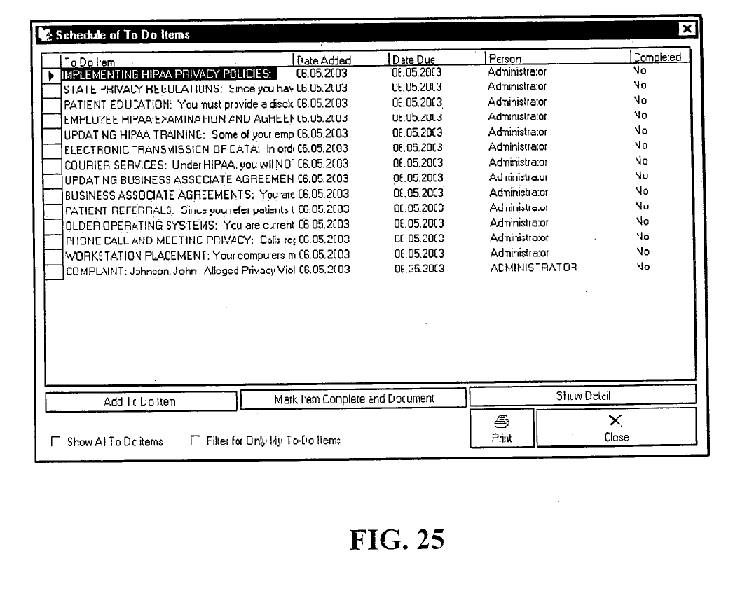

### DETAILED DESCRIPTION OF PREFERRED EMBODIMENT

The present invention relates to a method of providing complete HIPAA privacy compliance in an integrated computer software package and process that utilizes “wizard” screens, a video training manager, a disclosure database, a business associates database and manager, and a forms database.

### Assessment Wizard

The software provides a series of “wizard” screens that present the business user questions about the condition of their office and business in respect to privacy. The wizard screens consist of a series of logical checkboxes and option buttons the user selects. Some text boxes and combo-boxes are also used to provide information to the wizard. There are multiple screens used in successession.

The software assesses, based on the answers given by the user on the “wizard” screens and the objective rules contained in the privacy guidelines, whether the objective rules allow disclosure.

The software, after assessing whether disclosure is allowed, provides a set of results to the business user indicating what steps need to be taken in order for the business user to comply with the objective rules for disclosure. Optionally, if requested by the business user, the software will place these steps in a schedule and organized list to help remind the business user.

### Protected Health Information Disclosure Wizard

The software provides a series of “wizard” screens that ask the user questions about the particular disclosure of protected information the user is proposing to make and recording each answer made.

Based on the recorded answers given in the wizard, the software asks additional questions only as required based on the prior answers given and recorded in the prior wizard screens. Thereafter, the software determines, using the recorded process, whether the particular disclosure is permitted under the law based on the answers given by the user by scoring and comparing the answers given. The system can also be configured to query its own internal databases to see if all necessary agreements and/or paperwork are in-place before disclosure is made;

The software rejects proposed disclosure where disclosure is not allowed after system makes determination; or

Provides user with requirements and list of things that must be completed where the disclosure would be allowed if certain paperwork and agreements were in-place. Prints required agreements and paperwork for user or emails or electronically provides information as required.

Alternatively, the software allows disclosure and records where information is sufficient for disclosure after evaluating answers given by user and following process based statutory analysis within software;

Once the disclosure wizard completes its assessment, the user may complete the required work and then disclose the information according to the results provided by the software. The user is then afforded the opportunity to record the disclosure in the disclosure database included in the software when the software indicates that a disclosure recording is necessary.

### Training Manager

The software provides an interconnected training manager having a series of training videos that are displayed using video playback components (Windows Media Player) to display HIPAA-Privacy specific information for employees of the provider;

Once the videos have been completed, the employee is then given a test that must be passed.

Once the test is passed, a HIPAA compliance agreement is printed and provided to the employee for signature and the test results recorded in the database and maintained.

Once the agreement is signed, the information on the test and the agreement are stored in a database that is a part of the software. This database is used by the wizards and other parts of the program to provide a complete HIPAA-Privacy solution.

### Disclosure Database

The disclosure database provides a method for storing disclosure data, including the particulars recorded after the user has completed the disclosure wizard.

Each disclosure is recorded and can be viewed by searching or by moving through the database. As the user navigates through the database using the arrow keys or mouse, the appropriate disclosure information displays below the selected patient name.

The disclosure database is included to allow the software to act as a complete process for the provider in becoming and maintaining HIPAA-Privacy compliance.

### Business Associate Database and Manager

The software includes a system for printing, tracking and recording all business associate agreements in-place between the provider and his/her business associates.

The business associate data is used by the disclosure wizard and database in determining what types of disclosures are necessary and ensuring disclosures are not made when the required agreements are not in-place.

### Forms Database

The software includes a FORMS database that stores all HIPAA-Privacy related forms, including required patient disclosure forms, notification forms, forms for agreements with other providers, consent forms and other forms that can be added as necessary by the provider.

The forms database is included to allow the software to act as an interconnected complete process for the provider in becoming and maintaining HIPAA-Privacy compliance.

### Reporting and Updating

The system also provides reporting features tied to the processes within the program. For each process, reports are available to the user.

Using an internet connection, the software processes remain up-to-date with any changes to the regulations on an “on demand” process when the user clicks the update button.

The reporting and updating system is included to allow the software to act as an interconnected and complete process for the provider in becoming and maintaining HIPAA-Privacy compliance.

### Integrated HIPAA-Privacy Software

The software incorporates all of the steps recited in claims 1 through 6 in an integrated manner that allows the user to become compliant through the interconnected and series of processes contained in the claims.

WHEREBY, the software provides a complete HIPAA-Privacy solution in a combined process easily installable on a computer system. All of the privacy requirements are covered by the software in a variety of processes that are interconnected.

WHEREBY, the user of the software can install the software, get an analysis of requirements applicable to their business, use the software to maintain compliance with the statute for all areas where the privacy portion of HIPAA applies to healthcare providers and do all of this with a relational process embedded in the single software package.

The above description is considered that of the preferred embodiment only. Modifications of the invention will occur to those skilled in the art and to those who make or use the invention. Therefore, it is understood that the embodiment shown in the drawings and described above is merely for illustrative purposes and not intended to limit the scope of the invention, which is defined by the following claims as interpreted according to the principles of patent law, including the doctrine of equivalents.

The invention claimed is:

1. A method for determining whether a business user in possession of confidential information of an individual may disclose said information in accordance with objective rules voluntarily adopted by the business user or required by law, the method comprising:
(a) providing a series of “wizard” screens that present the user questions about the condition of their office and the business with respect to privacy in a series of logical checkboxes and option buttons that the user selects;
(b) assessing, based on the answers given by the user on the wizard screens and the objective rules;
(c) providing a set of results to the business user indicating what steps need to be taken in order for the business user to comply with said objective rules for disclosure.
